(19) United States
(12) Patent Application Publication
(10) Pub. No.: US 2017/0134780 A1
(43) Pub. Date: May 11, 2017

(54) MOVIE DATA DISPLAY METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventors: Lihu ZHANG, Beijing (CN); Libiao WANG, Beijing (CN); Xiaoyang ZHAO, Beijing (CN); Min YAN, Beijing (CN)

(73) Assignees: LE HOLDINGS (BEIJING) CO., LTD., Beijing (CN); LE SHI ZHI XIN ELECTRONIC TECHNOLOGY (TIANJIN) LIMITED, Beijing (CN)

(21) Appl. No.: 15/242,363

(22) Filed: Aug. 19, 2016

Related U.S. Application Data
(63) Continuation of application No. PCT/CN2016/087743, filed on Jun. 29, 2016.

(30) Foreign Application Priority Data
Nov. 9, 2015 (CN) 201510757841.1

(51) Int. Cl. H04N 21/2543; H04N 21/488; H04N 21/2187; H04N 21/482; H04N 21/431; H04N 21/478

(52) U.S. Cl. CPC H04N 21/2543; H04N 21/4312; H04N 21/478; H04N 21/2187; H04N 21/4821; H04N 21/4882

(57) ABSTRACT

Disclosed are a movie data display method and device, including: when receiving an instruction of triggering first movie information of a user on an interface where a list of at least one piece of movie information is displayed, popping up a first popup window, wherein the first popup window includes a play time of the first movie information and a ticket amount corresponding to the play time; after receiving a ticket purchase instruction of the ticket amount corresponding to the first play time of the first movie information in the first popup window, popping up a second popup window for payment; and after receiving a ticket purchase confirmation instruction in the second popup window, obtaining live broadcast stream of the first movie information in a server according to an identifier of the first movie information, and displaying the live broadcast stream to the user at the first play time.

### CROSS-REFERENCE TO RELATED APPLICATIONS

This application is a continuation of International Application No. PCT/CN20161087743, filed on Jun. 29, 2016, which is based upon and claims priority to Chinese Patent Application No. 2015107578411,filed on Nov. 9, 2015, the entire contents of which are incorporated herein by reference.

### TECHNICAL FIELD

The disclosure relates to the technical field of data play, and in particular, to a movie data display method and device.

### BACKGROUND

A smart TV is an intelligent multimedia terminal that occurs complying with the trends of “high definition”, “networking” and “intelligence” of TV sets, and has the functions of obtaining program contents from a variety of channels, such as the Internet, video equipment and computers or the like, and clearly displaying the most necessary contents of consumers on a large screen by a simple and feasible integrated operation interface.

A traditional cinema viewing mode occurs for a long time, the demands of the young for going to cinemas are stronger and stronger at present, the young is gradually used to this viewing demand, but time requirements are present when seeing movies in the cinemas, for some relatively popular films, a full field phenomenon occurs usually, and even tickets at noon or at night can be only bought when queuing to purchase the tickets in the morning, resulting in that the waiting time for viewing of the users is long, therefore, how to provide offline movies for the users on the smart TVs becomes a problem to be solved urgently.

### SUMMARY

In view of the technical problems in the prior art, embodiments of the present disclosure provide a movie data display method and device, so as to provide offline movies for users on smart TVs and improve the viewing experience of the users.

According to a first aspect, the present disclosure provides a movie data display method, including:

when receiving an instruction of triggering first movie information of a user on an interface where a list of at least one piece of movie information is displayed, popping up a first popup window, wherein the first popup window includes a play time of the first movie information and a ticket amount corresponding to the play time;

after receiving a ticket purchase instruction of the ticket amount corresponding to the first play time of the first movie information in the first popup window, popping up a second popup window for payment; and

after receiving a ticket purchase confirmation instruction in the second popup window, obtaining live broadcast stream of the first movie information in a server according to an identifier of the first movie information, and displaying the live broadcast stream to the user at the first play time.

According to a second aspect, the present disclosure further provide an electronic device, including a memory and at least one central processing unit, where the memory is connected to the at least on central processing unit by using a bus, the memory is configured to store a computer instruction, and when the device runs, the at least on central processing units executes the device to execute the following operations:

when receiving an instruction of triggering first movie information of a user on an interface where a list of at least one piece of movie information is displayed, popping up a first popup window, wherein the first popup window includes a play time of the first movie information and a ticket amount corresponding to the play time; after receiving a ticket purchase instruction of the ticket amount corresponding to the first play time of the first movie information in the first popup window, popping up a second popup window for payment; after receiving a ticket purchase confirmation instruction in the second popup window, obtaining live broadcast stream of the first movie information in a server according to an identifier of the first movie information; and displaying the live broadcast stream to the user at the first play time.

According to a third aspect, the present disclosure further provide a non-volatile computer readable storage medium, where the non-volatile computer readable storage medium stores a computer instruction, and a computer executes the computer instruction to execute the following operations:

when receiving an instruction of triggering first movie information of a user on an interface where a list of at least one piece of movie information is displayed, popping up a first popup window, wherein the first popup window includes a play time of the first movie information and a ticket amount corresponding to the play time;

after receiving a ticket purchase instruction of the ticket amount corresponding to the first play time of the first movie information in the first popup window, popping up a second popup window for payment; and

after receiving a ticket purchase confirmation instruction in the second popup window, obtaining live broadcast stream of the first movie information in a server according to an identifier of the first movie information; and

displaying the live broadcast stream to the user at the first play time.

According to the movie data display method and device provided by the present disclosure, the interface of the list of the at least one piece of movie information is displayed to the user, so that the user selects the movie information of a movie he/she wants to view in the interface, when the user selects the movie information, the popup window is popped up, including the play time of the movie information selected by the user and the ticket amount corresponding to the play time, and the user selects a viewing time period according to his/her own time and pays corresponding fees. After the ticket purchase confirmation instruction is received, the live broadcast stream is displayed to the user, so as to play the movies that are shown in offline cinemas. As an operation mode similar to the cinema is adopted to recommend the latest and the hottest movies for the user, the user can view the movies that are shown in the offline cinemas at home, and thus the viewing experience of the user is improved.

### BRIEF DESCRIPTION OF THE DRAWINGS

To illustrate technical solutions in the embodiments of the present disclosure or in the prior art more clearly, a brief introduction on the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a schematic diagram of a flow of a movie data display method provided by one embodiment of the present disclosure;

FIG. 2 is a schematic diagram of a list of movie information provided by one embodiment of the present disclosure;

FIG. 3 is a schematic diagram of a structure of movie contents provided by one embodiment of the present disclosure;

FIG. 4 is a schematic diagram of a flow of a movie data display method provided by another embodiment of the present disclosure;

FIG. 5 is a schematic diagram of a flow of a movie data display method provided by another embodiment of the present disclosure;

FIG. 6 is a schematic diagram of a structure for setting movie session prices provided by one embodiment of the present disclosure;

FIG. 7 is a schematic diagram of a structure of a movie data display device provided by one embodiment of the present disclosure;

FIG. 8 is a schematic diagram of a structure of a movie data display device provided by another embodiment of the present disclosure;

FIG. 9 is a logic block diagram of a movie data display device of one embodiment of the present disclosure; and

FIG. 10 is a logic block diagram of a movie data display device of another embodiment of the present disclosure

### DETAILED DESCRIPTION

In order to make the objects, technical solutions and advantages of the present disclosure clearer, a clear and complete description of the technical solutions in the embodiments of the present disclosure will be given below, in combination with the accompanying drawings in the embodiments of the present disclosure. Apparently, the embodiments described below are merely a part, but not all, of the embodiments of the present disclosure. All of other embodiments, obtained by those of ordinary skill in the art based on the embodiments of the present disclosure without any creative effort, fall into the protection scope of the present disclosure.

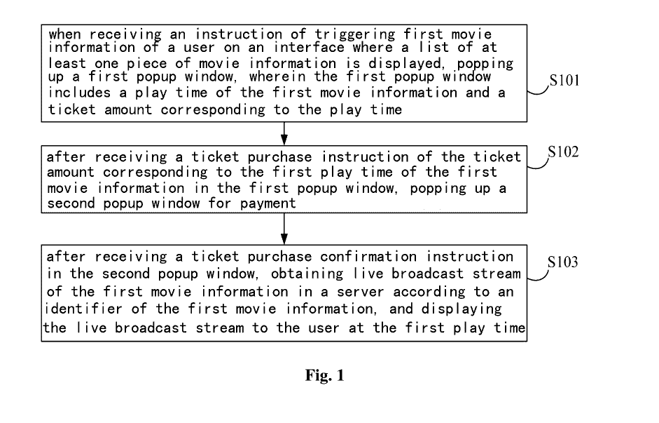

FIG. 1 shows a schematic diagram of a flow of a movie data display method provided by one embodiment of the present disclosure. As shown in FIG. 1, the method includes the following steps:

S101, when an instruction of triggering first movie information of a user is received on an interface where a list of at least one piece of movie information is displayed, a first popup window is popped up, wherein the first popup window includes a play time of the first movie information and a ticket amount corresponding to the play time.

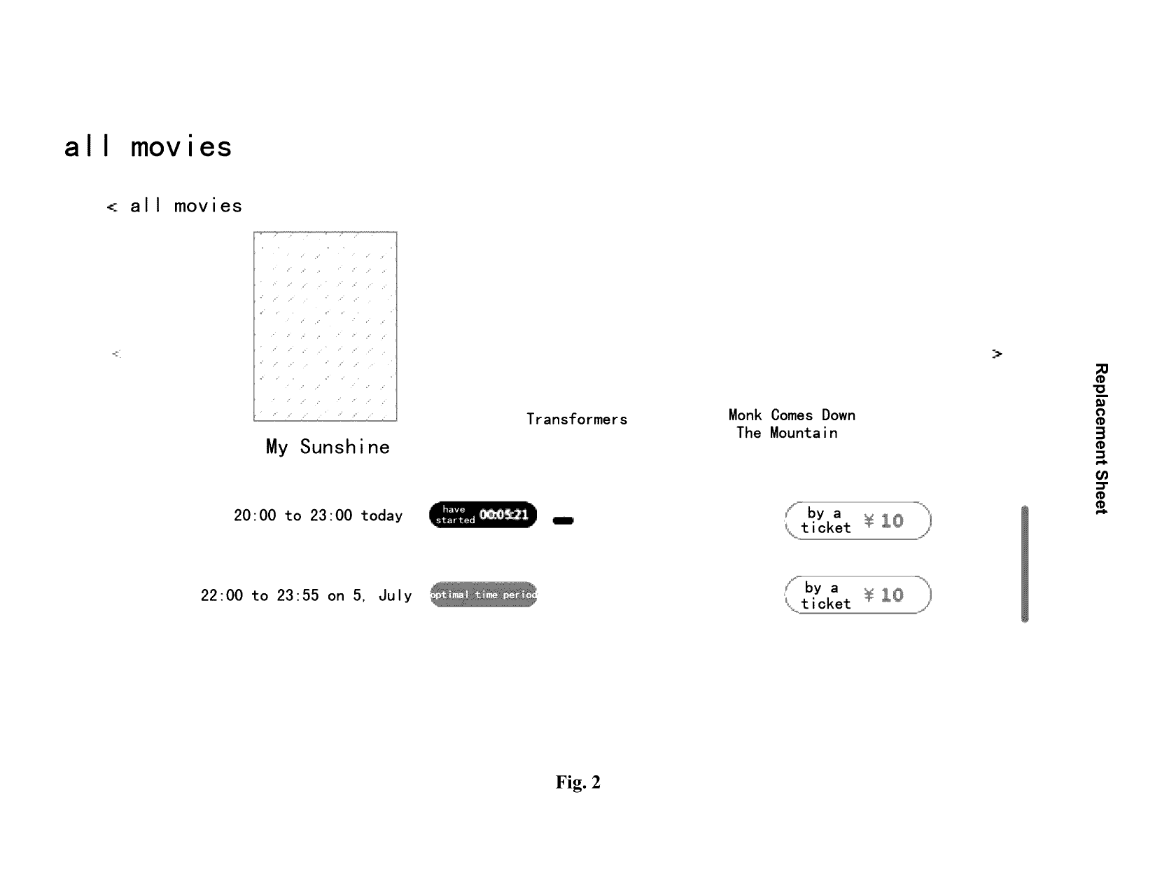

As shown in FIG. 2, the list of the movie information includes “My Sunshine”, “Transformers”, “Monk Comes Down The Mountain” and other movie information, when a user operates a certain piece of movie information (for example, a click operation), the play time of the movie information and the ticket amount corresponding to the play time of the corresponding operation will occur, for example, when the user clicks the “My Sunshine”, the play time of the movie information and the ticket amount corresponding to the play time will occur.

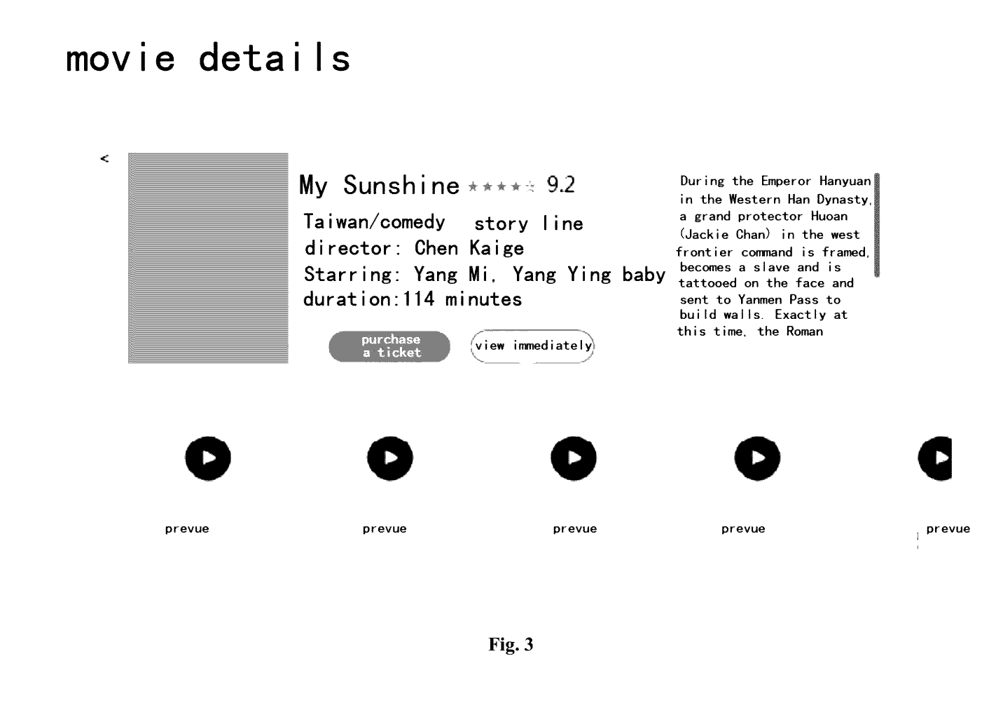

When a mouse or the like of the user clicks the corresponding movie information again, the movie contents of the movie information as shown in FIG. 3 will be displayed to the user, and the movie contents can include a brief introduction of the movie, a category of the movie, a director of the movie, actors of the movie, a duration of the movie and a prevue of the movie and the like, so that the user can understand the movie information.

S102, after a ticket purchase instruction of the ticket amount corresponding to the first play time of the first movie information is received in the first popup window, a second popup window is popped up for payment.

The second popup window for payment will be popped up when the user clicks to buy a ticket, and the user buys the ticket in the second popup window by Alipay or E-bank or Wechat or other forms.

S103, after a ticket purchase confirmation instruction in the second popup window is received, live broadcast stream of the first movie information is obtained in a server according to an identifier of the first movie information, and the live broadcast stream is displayed to the user at the first play time.

According to the above method, the interface of the list of the at least one piece of movie information is displayed to the user, so that the user selects the movie information of the movie he/she wants to view in the interface, when the user selects the movie information, the popup window is popped up, including the play time of the movie information selected by the user and the ticket amount corresponding to the play time, and the user selects a viewing time period according to his/her own time and pays corresponding fees. After the ticket purchase confirmation instruction is received, the live broadcast stream is displayed to the user, so as to play the movies that are shown in offline cinemas. As an operation mode similar to the cinema is adopted to recommend the latest and the hottest movies for the user, the user can view the movies that are shown in the offline cinemas at home, and thus the viewing experience of the user is improved.

Before the list of at least one piece of movie information is displayed in step S101, the method further includes the following step that is not shown in FIG. 1:

obtaining the instruction of obtaining the list of at least one piece of movie information triggered by the user, obtaining the list from the server, and displaying the list to the user.

It can be understood that, when the user opens the network television and selects to view a movie, the instruction of obtaining the list of at least one piece of movie information will be sent to the server, at this time, when receiving the instruction, the server will display the list on the interface of the network television of the user, so as to display the movie information that is shown offline at present or is about to be shown to the user.

Step S103 of displaying the live broadcast stream to the user at the first play time specifically includes the following steps:

S1031, a display time of displaying the live broadcast stream to the user is determined according to a relation of the first display time and the current time.

Step S1031 may include the two following conditions:

in a first condition, when the first display time is earlier than or equal to the current time, the live broadcast stream is displayed to the user at the current time; and

for example, the first display time is 20:00 on 4, Jul., and the current time is 20:05 on 4, Jul., then the live broadcast stream is directly displayed to the user after the payment of the user.

Or,

in a second condition, when the first display time is latter than the current time, the live broadcast stream is displayed to the user at the first display time.

For example, the current time is 20:05 on 4, Jul., and the first display time is 22:00 on 5, Jul., then the live broadcast stream is displayed to the user at 22:00 on 5, Jul. after the payment of the user.

If the first display time is latter than the current time exceeding a preset time, for example, half an hour, information for reminding the user to view the live broadcast stream at the first display time will be sent to the user within half an hour prior to the first display time. The reminding can be sent by a short message or a mail or in other forms, a specific contact way, such as a mobile phone number or a mail or the like can be obtained according to a registered ID of the user, and the specific obtaining details will not be illustrated in detail in the embodiment.

Of course, prior to a preset time period before the first play time, for example, the first display time is 22:00, the preset time period is half an hour, if the user is engaged and cannot view the movie at the first play time, the user can send a refund request before 21:30, if the request of the user is not received before 21:30, it is defaulted that the user will view the movie at the first play time, the first play time in the embodiment is similar to the movie play time of the offline cinema, it can also be understood that if the user cannot view the movie at the first play time after purchasing the ticket, the payment will not be returned, in addition, the user cannot carry out fast forward, back off and other operations in a viewing process, the user will miss a part of movie contents if leaving in the play process, and no review is supported.

S1032, the live broadcast stream is displayed to the user according to the display time.

The above method can be understood in such a manner that a movie theater App, namely the client installed in the network television displays the live broadcast stream to the user.

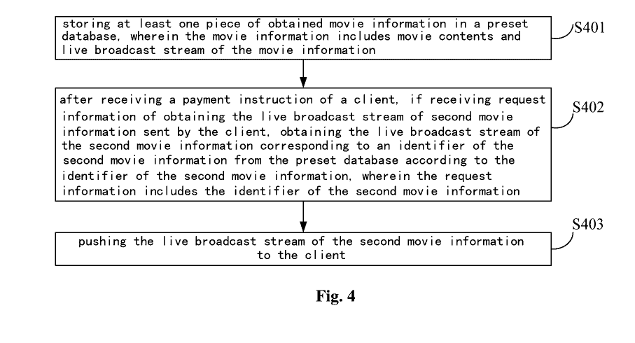

FIG. 4 shows a schematic diagram of a flow of a movie data display method provided by the embodiment of the present disclosure. As shown in FIG. 4, the method includes the following steps:

S401, at least one piece of obtained movie information is stored in a preset database, wherein the movie information includes movie contents and live broadcast stream of the movie information.

The above step can be understood in such a manner that, a network television server will periodically obtain the movie information, store the movie information in the preset database and integrate the information of media assets, Lehai and live broadcast, the details of the information obtained from various channels are as follows: media assets: movie contents, including titles, descriptions, posters, actors, directors, prevues, stage photos and scores; Lehai: offline movie information, including scores, and information indicating how many cinemas show how many sessions at the current time; and the live broadcast stream of the movie information: providing the live broadcast stream of the movies, which is divided into three paths of live broadcast stream of high definition, standard definition and super definition.

S402, after a payment instruction of a client is received, if request information of obtaining the live broadcast stream of second movie information sent by the client is received, the live broadcast stream of the second movie information corresponding to an identifier of the second movie information is obtained from the preset database according to the identifier of the second movie information, wherein the request information includes the identifier of the second movie information.

The identifier of the second movie information can be understood as a title of the movie or an ID of the movie or the like, and this is not limited in the embodiment.

S403, the live broadcast stream of the second movie information is pushed to the client.

According to the above method, the movie information is obtained, the movie information is stored in the preset database, after the payment instruction of the client is received, if the request information of obtaining the live broadcast stream of the second movie information sent by the client is received, the live broadcast stream of the second movie information corresponding to the identifier of the second movie information is obtained from the preset database according to the identifier of the second movie information, and the live broadcast stream is pushed to the client at a play time selected by the user. The user can directly purchase the wanted movie through the App on the network television and view the movie at the selected time period, thereby avoiding queuing to purchase the tickets in the cinemas, saving the waiting time for viewing and improving the viewing experience of the user.

The process of displaying the movie data through the interaction of the client App and the server in the method as shown in FIG. 1 and FIG. 4 will be illustrated below in detail.

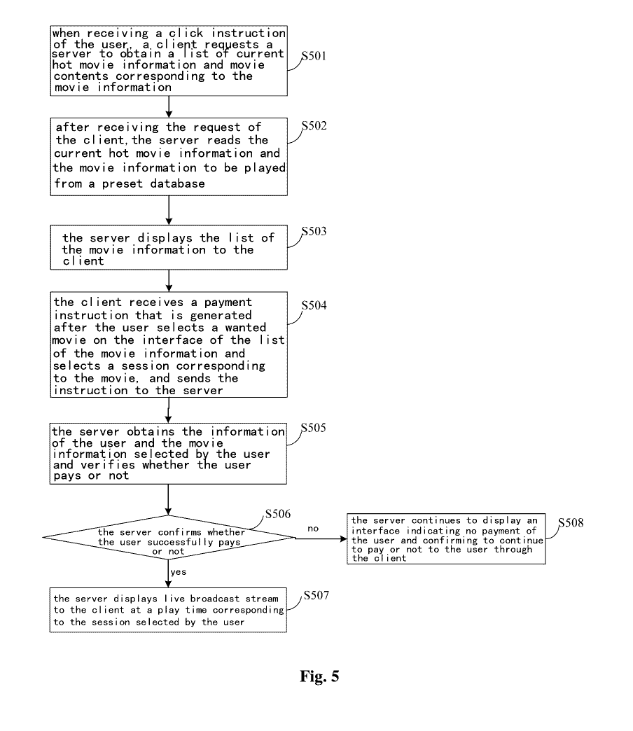

FIG. 5 shows a schematic diagram of a flow of a movie data display method provided by the embodiment of the present disclosure. As shown in FIG. 5, the method includes the following steps:

S501, when receiving a click instruction of the user, a client requests a server to obtain a list of current hot movie information and movie contents corresponding to the movie information;

S502, after receiving the request of the client, the server reads the current hot movie information and the movie information to be played from a preset database;

S503, the server displays the list of the movie information to the client;

S504, the client receives a payment instruction that is generated after the user selects a wanted movie on the interface of the list of the movie information and selects a session corresponding to the movie, and sends the instruction to the server;

S505, the server obtains the information of the user and the movie information selected by the user and verifies whether the user pays or not;

S506, the server confirms whether the user successfully pays or not, if so, step S507 is executed, and otherwise, step S508 is executed;

S507, after determining that the user successfully pays, the server displays live broadcast stream to the client at a play time corresponding to the session selected by the user; and

S508, if determining that the user unsuccessfully pays, the server continues to display an interface indicating no payment of the user and confirming to continue to pay or not to the user through the client.

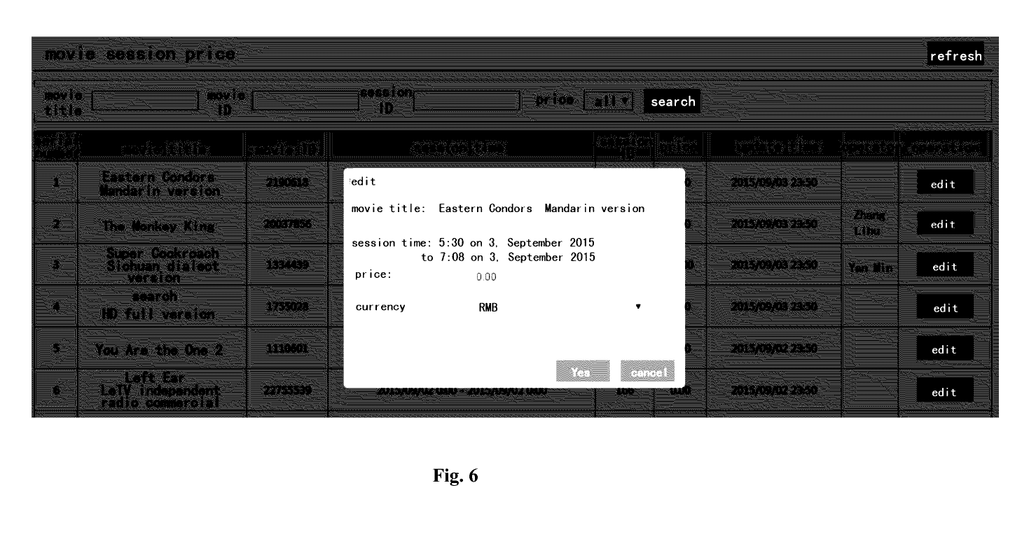

In the above method, the server can also receive an operation of a background manager of modifying the session of the movie information and the price corresponding to the session through the interface as shown in FIG. 6 and update the modified price.

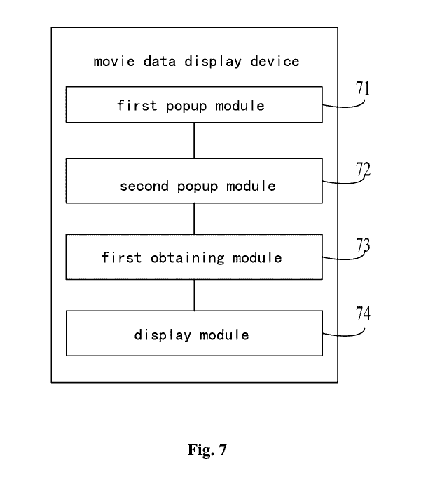

FIG. 7 shows a schematic diagram of a structure of a movie data display device provided by the embodiment of the present disclosure. As shown in FIG. 7, the device includes:

a first popup module 71 used for, when receiving an instruction of triggering first movie information of a user on an interface where a list of at least one piece of movie information is displayed, popping up a first popup window, wherein the first popup window includes a play time of the first movie information and a ticket amount corresponding to the play time;

a second popup module 72 used for, after receiving a ticket purchase instruction of the ticket amount corresponding to the first play time of the first movie information in the first popup window, popping up a second popup window for payment;

a first obtaining module 73 used for, after receiving a ticket purchase confirmation instruction in the second popup window, obtaining live broadcast stream of the first movie information in a server according to an identifier of the first movie information, and

a display module 74, used for displaying the live broadcast stream to the user at the first play time.

In an optional implementation manner of the embodiment, the first obtaining module 73 is further used for obtaining an instruction of obtaining the list of at least one piece of movie information triggered by the user and obtaining the list from the server; and

the display module 74 is further used for displaying the list to the user.

In an optional implementation manner of the embodiment, the display module 74 is used for:

determining a display time of displaying live broadcast stream to the user according to a relation of the first display time and the current time; and

displaying live broadcast stream to the user according to the display time.

In an optional implementation manner of the embodiment, the display module 74 is used for:

when the first display time is earlier than or equal to the current time, displaying the live broadcast stream to the user at the current time;

or,

the display module 74 is further used for, when the first display time is latter than the current time, displaying the live broadcast stream to the user at the first display time.

In an optional implementation manner of the embodiment, the device further includes the following module not shown in FIG. 7:

a sending module, used for sending information for reminding the user to view the live broadcast stream at the first display time to the user within a preset time period prior to the first display time.

It should be noted that, the device as shown in FIG. 7 is in one-to-one correspondence with the method as shown in FIG. 1, specific implementation details of the method are also applicable to the device, and thus the specific implementation details of the device will not be illustrated in detail in the embodiment.

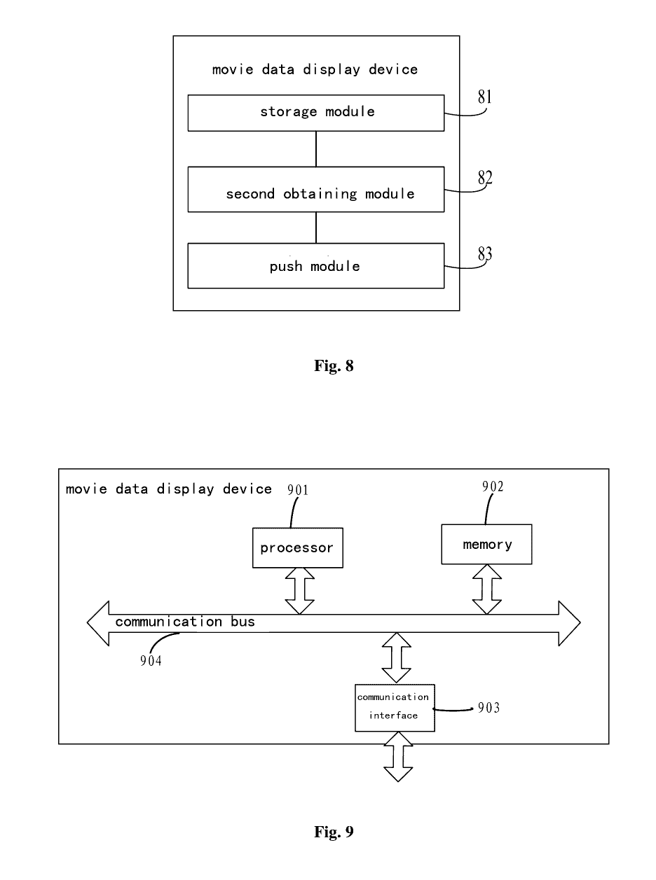

FIG. 8 shows a schematic diagram of a structure of a movie data display device provided by the embodiment of the present disclosure. As shown in FIG. 8, the device includes:

a storage module 81, used for storing at least one piece of obtained movie information in a preset database, wherein the movie information includes movie contents and live broadcast stream of the movie information;

a second obtaining module 82 used for, after receiving a payment instruction of a client, if receiving request information of obtaining the live broadcast stream of second movie information sent by the client, obtaining the live broadcast stream of the second movie information corresponding to an identifier of the second movie information from the preset database according to the identifier of the second movie information, wherein the request information includes the identifier of the second movie information; and

a push module 83, used for pushing the live broadcast stream of the second movie information to the client.

It should be noted that, the device as shown in FIG. 8 is in one-to-one correspondence with the method as shown in FIG. 4, specific implementation details of the method are also applicable to the device, and thus the specific implementation details of the device will not be illustrated in detail in the embodiment.

FIG. 9 is a logic block diagram of a movie data display device of one embodiment of the present disclosure. Refer to FIG. 9, the movie data display device, including:

a processor 901, a memory 902, a communication interface 903 and a bus 904, wherein

the processor 901, the memory 902 and the communication interface 903 complete intercommunication through the bus 904;

the communication interface 903 is used for information transmission between a server and communication equipment of a client;

the processor 901 is used for invoking logical instructions in the memory 902 to perform the following method:

when receiving an instruction of triggering first movie information of a user on an interface where a list of at least one piece of movie information is displayed, popping up a first popup window, wherein the first popup window includes a play time of the first movie information and a ticket amount corresponding to the play time; after receiving a ticket purchase instruction of the ticket amount corresponding to the first play time of the first movie information in the first popup window, popping up a second popup window for payment; after receiving a ticket purchase confirmation instruction in the second popup window, obtaining live broadcast stream of the first movie information in a server according to an identifier of the first movie information; and displaying the live broadcast stream to the user at the first play time.

See FIG. 1, the embodiment of the present disclosure discloses a computer program, including program codes for performing the following operations:

when receiving an instruction of triggering first movie information of a user on an interface where a list of at least one piece of movie information is displayed, popping up a first popup window, wherein the first popup window includes a play time of the first movie information and a ticket amount corresponding to the play time;

after receiving a ticket purchase instruction of the ticket amount corresponding to the first play time of the first movie information in the first popup window, popping up a second popup window for payment; and

after receiving a ticket purchase confirmation instruction in the second popup window, obtaining live broadcast stream of the first movie information in a server according to an identifier of the first movie information; and

displaying the live broadcast stream to the user at the first play time.

The embodiment of the present disclosure discloses a storage medium, used for storing the computer program above.

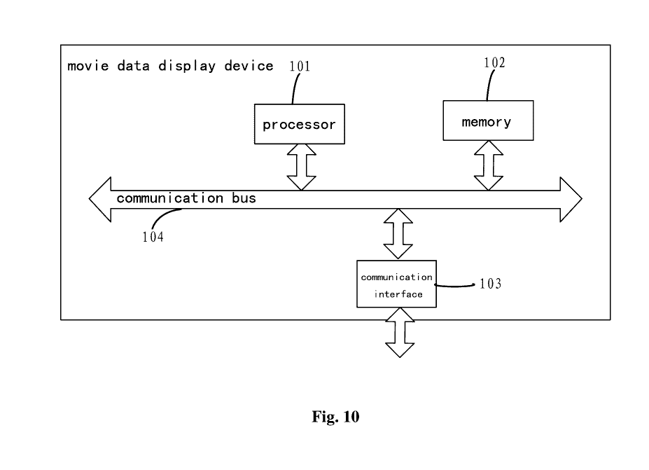

FIG. 10 is a logic block diagram of a movie data display device of another embodiment of the present disclosure. Refer to FIG. 10, the movie data display device, including:

a processor 101, a memory 102, a communication interface 103 and a bus 104, wherein

the processor 101, the memory 102 and the communication interface 103 complete intercommunication through the bus 104;

the communication interface 103 is used for information transmission between a server and communication equipment of a client;

the processor 101 is used for invoking logical instructions in the memory 102 to perform the following method:

storing at least one piece of obtained movie information in a preset database, wherein the movie information includes movie contents and live broadcast stream of the movie information; after receiving a payment instruction of a client, if receiving request information of obtaining the live broadcast stream of second movie information sent by the client, obtaining the live broadcast stream of the second movie information corresponding to an identifier of the second movie information from the preset database according to the identifier of the second movie information, wherein the request information includes the identifier of the second movie information; and pushing the live broadcast stream of the second movie information to the client.

See FIG. 4, the embodiment of the present disclosure discloses a computer program, including program codes for performing the following operations:

storing at least one piece of obtained movie information in a preset database, wherein the movie information includes movie contents and live broadcast stream of the movie information;

after receiving a payment instruction of a client, if receiving request information of obtaining the live broadcast stream of second movie information sent by the client, obtaining the live broadcast stream of the second movie information corresponding to an identifier of the second movie information from the preset database according to the identifier of the second movie information, wherein the request information includes the identifier of the second movie information; and

pushing the live broadcast stream of the second movie information to the client.

FIGS. 9-10 are schematic diagrams of a hardware structure of an electronic device for executing a processing method of list item operations provided by the embodiments of the disclosure. The device includes: one or more processors and a memory, with one processor as an example in FIGS. 9-10.

The device for executing a processing method of list item operations provided by the embodiments of the disclosure may also include: an input device and an output device.

As a non-volatile computer-readable storage medium, the memory is available for storing non-volatile software programs, non-volatile computer-executable programs and modules, such as program instructions/modules corresponding to the processing method of list item operations in the embodiments of the present disclosure. By running non-volatile software programs, instructions and modules stored in the memory, the processor executes various function applications and data processing of a server, i.e., achieving the processing method of list item operations in the above method embodiments.

The memory may include a program storage region and a data storage region, wherein the program storage region is available for storing an operating system, and at least one functionally required application; the data storage region is available for storing data created according to the use of a processing device of list item operations, and the like. In addition, the memory may include a high-speed random access memory, and may also include a non-volatile memory, such as at least one magnetic disk storage device, a flash memory device, or other non-volatile solid-state storage devices. In some embodiments, the memory optionally includes memories remotely set with respect to the processor; these remote memories are connectable to the processing device of list item operations by means of networks. Examples of the networks include, but are not limited to, Internet, Intranet, LAN, mobile communication networks and combinations thereof.

The input device is capable of receiving input digit or character information, and producing key signal inputs related to user settings and function control of the processing device of list item operations. The output device may include a display device such as a display screen.

The one or more modules are stored in the memory, and execute the processing method of list item operations in any above method embodiment when executed by the one or more processors.

The products described above are capable of executing the method provided by the embodiments of the present disclosure, and has corresponding function modules for executing the method and beneficial effects. Those technical details not described in detail in the present embodiment may be found in the method provided by the embodiments of the present disclosure.

The electronic device provided by this embodiment of the present disclosure may be present in a plurality of forms, including but not limited to:
(1) Mobile communication equipment: such equipment is characterized by mobile communication functions and mainly intended to provide voice and data communications. Terminals of this type include: smart phones (e.g., iPhone), multimedia mobile phones, functional mobile phones, low-end mobile phones and so on.
(2) Ultra-mobile personal computer equipment: such equipment falls into the category of personal computers, has computing and processing functions, and generally also has a mobile network access characteristic. Terminals of this type include: PDA, MID, UMPC equipment, and the like, for example iPad.
(3) Portable entertainment equipment: such equipment is able to display and play multimedia contents, and includes: audio and video players (e.g., iPod), handheld game players, electronic book readers, and smart toys and portable vehicle-mounted navigation equipment.
(4) Servers: they are equipment providing computing service. Components of a server include a processor, a hard disk, a memory, a system bus and the like. The architecture of a server is similar to that of a general-purpose computer; however, since servers are required to provide highly reliable services, requirements in such aspects as processing ability, stability, reliability, safety, extendibility and manageability are relatively high.
(5) Other electronic devices having the function of data interaction.

The embodiment of the present disclosure discloses a storage medium, used for storing the computer program as described by the embodiment above. The device embodiments described above are merely schematic, wherein the units described as separate components can be separated physically or not, components displayed as units can be physical units or not, namely, can be located in one place, or can be distributed on a plurality of network units. A part of or all of the modules can be selected to implement the purposes objects of the solutions in the embodiments according to actual demands. Those of ordinary skill in the art can understand and implement the embodiments without any creative effort.

By means of the above descriptions of the embodiments, those skilled in the art can clearly understand that the embodiments can be implemented by software and necessary universal hardware platforms, and of course can also be implemented by hardware. Based on this understanding, the technical solutions essentially or the parts contributing to the prior art can be embodied in the form of a software product, the computer software product can be stored in a computer readable storage medium, such as a ROM/RAM, a magnetic disk, an optical disk or the like, and include several instructions for instructing a computer device (can be a personal computer, a server, or a network device or the like) to perform the methods in the embodiments or some parts of the embodiments.

Finally, it should be noted that the above embodiments are merely used for illustrating, rather than limiting the technical solutions of the embodiments of the present disclosure. Although the present disclosure has been described in detail with reference to the foregoing embodiments, those of ordinary skill in the art should understand that they could still make modifications to the technical solutions stated in the foregoing embodiments or make equivalent substitutions to a part of technical features therein; and these modifications or substitutions do not make the essence of the corresponding technical solutions depart from the spirit and scope of the technical solutions of the embodiments of the present disclosure.

What is claimed is:

1. A movie data display method, performing the method at an electronic device, comprising:
when receiving an instruction of triggering first movie information of a user on an interface where a list of at least one piece of movie information is displayed, popping up a first popup window, wherein the first popup window comprises a play time of the first movie information and a ticket amount corresponding to the play time;
after receiving a ticket purchase instruction of the ticket amount corresponding to the first play time of the first movie information in the first popup window, popping up a second popup window for payment; and
after receiving a ticket purchase confirmation instruction in the second popup window, obtaining live broadcast stream of the first movie information in a server according to an identifier of the first movie information, and displaying the live broadcast stream to the user at the first play time.

2. The method of claim 1, wherein before displaying the list of at least one piece of movie information on the interface, the method further comprises:
obtaining an instruction of obtaining the list of at least one piece of movie information triggered by the user, obtaining the list from the server, and displaying the list to the user.

3. The method of claim 1, wherein the displaying the live broadcast stream to the user at the first play time comprises:
determining a display time of displaying live broadcast stream to the user according to a relation of the first display time and the current time; and
displaying live broadcast stream to the user according to the display time.

4. The method of claim 3, wherein the determining a display time of displaying live broadcast stream to the user according to a relation of the first display time and the current time comprises:
when the first display time is earlier than or equal to the current time, displaying the live broadcast stream to the user at the current time;
or,
when the first display time is latter than the current time, displaying the live broadcast stream to the user at the first display time.

5. The method of claim 4, wherein before displaying the live broadcast stream to the user at the first display time, the method further comprises:
sending information used for reminding the user to view the live broadcast stream at the first display time to the user within a preset time period prior to the first display time.

6. An electronic device, comprising:
at least one processor; and
a memory communicably connected with the at least one processor for storing instructions executable by the at least one processor, wherein execution of the instructions by the at least one processor causes the at least one processor to:
when receiving an instruction of triggering first movie information of a user on an interface where a list of at least one piece of movie information is displayed, popping up a first popup window, wherein the first popup window comprises a play time of the first movie information and a ticket amount corresponding to the play time;
after receiving a ticket purchase instruction of the ticket amount corresponding to the first play time of the first movie information in the first popup window, popping up a second popup window for payment;
after receiving a ticket purchase confirmation instruction in the second popup window, obtaining live broadcast stream of the first movie information in a server according to an identifier of the first movie information, and
displaying the live broadcast stream to the user at the first play time.

7. The device of claim 6, the processor is further configured to: obtain an instruction of obtaining the list of at least one piece of movie information triggered by the user and obtain the list from the server; and display the list to the user.

8. The device of claim 6, the processor is further configured to:
determine a display time of displaying live broadcast stream to the user according to a relation of the first display time and the current time; and
display live broadcast stream to the user according to the display time.

9. The device of claim 8, the processor is further configured to:
when the first display time is earlier than or equal to the current time, display the live broadcast stream to the user at the current time;
or,
when the first display time is latter than the current time, display the live broadcast stream to the user at the first display time.

10. The device of claim 9, the processor is further configured to:
send information used for reminding the user to view the live broadcast stream at the first display time to the user within a preset time period prior to the first display time.

11. A non-transitory computer-readable storage medium storing executable instructions that, when executed by an electronic device with a touch-sensitive display, cause the electronic device to:
when receiving an instruction of triggering first movie information of a user on an interface where a list of at least one piece of movie information is displayed, pop up a first popup window, wherein the first popup window comprises a play time of the first movie information and a ticket amount corresponding to the play time;
after receiving a ticket purchase instruction of the ticket amount corresponding to the first play time of the first movie information in the first popup window, pop up a second popup window for payment; and
after receiving a ticket purchase confirmation instruction in the second popup window, obtain live broadcast stream of the first movie information in a server according to an identifier of the first movie information; and
display the live broadcast stream to the user at the first play time.

12. The non-transitory computer-readable storage medium of claim 11, the electronic device is further configured to: obtain an instruction of obtaining the list of at least one piece of movie information triggered by the user and obtain the list from the server; and display the list to the user.

13. The non-transitory computer-readable storage medium of claim 11, the electronic device is further configured to:
determine a display time of displaying live broadcast stream to the user according to a relation of the first display time and the current time; and
display live broadcast stream to the user according to the display time.

14. The non-transitory computer-readable storage medium of claim 13, the electronic device is further configured to:
when the first display time is earlier than or equal to the current time, display the live broadcast stream to the user at the current time;
or,
when the first display time is latter than the current time, display the live broadcast stream to the user at the first display time.

15. The non-transitory computer-readable storage medium of claim 14, the electronic device is further configured to:
send information used for reminding the user to view the live broadcast stream at the first display time to the user within a preset time period prior to the first display time.
